(19) United States
(12) Patent Application Publication
(10) Pub. No.: US 2007/0291128 A1
(43) Pub. Date: Dec. 20, 2007

(54) Mobile teleconferencing system that projects an image provided by a mobile robot

(76) Inventors: Yulun Wang, Goleta, CA (US); Charles S. Jordan, Santa Barbara, CA (US); Marco Pinter, Santa Barbara, CA (US)

Correspondence Address: IRELL & MANELLA LLP, 840 NEWPORT CENTER DRIVE, SUITE 400, NEWPORT BEACH, CA, 92660, US

(21) Appl. No.: 11/455,161

(22) Filed: Jun. 15, 2006

(51) Int. Cl. H04N 5/232

(52) U.S. Cl. 348/211.2; 348/211.8; 348/E05.042; 901/1

(57) ABSTRACT

A remote controlled robot system that includes a mobile robot and a remote control station. The mobile robot includes a camera that captures an image. The remote control station may include a monitor that displays the image captured by the robot camera. A projector is coupled to the remote control station to project the image. The system allows for the projection of the image captured by the robot to a relatively large viewing audience. The audience can thus view images provided by a moving robot.

### BACKGROUND OF THE INVENTION

1. Field of the Invention

The subject matter disclosed generally relates to the field of mobile two-way teleconferencing.

2. Background Information

Robots have been used in a variety of applications ranging from remote control of hazardous material to assisting in the performance of surgery. For example, U.S. Pat. No. 5,762,458 issued to Wang et al. discloses a system that allows a surgeon to perform minimally invasive medical procedures through the use of robotically controlled instruments. One of the robotic arms in the Wang system moves an endoscope that has a camera. The camera allows a surgeon to view a surgical area of a patient.

Tele-robots such as hazardous waste handlers and bomb detectors may contain a camera that allows the operator to view the remote site. Canadian Pat. No. 2289697 issued to Treviranus, et al. discloses a teleconferencing platform that has both a camera and a monitor. The platform includes mechanisms to both pivot and raise the camera and the monitor. The Treviranus patent also discloses embodiments with a mobile platform, and different mechanisms to move the camera and the monitor.

There has been marketed a mobile robot introduced by InTouch Technologies, Inc., the assignee of this application, under the trademarks COMPANION and RP-6. The InTouch robot is controlled by a user at a remote station. The remote station may be a personal computer with a joystick that allows the user to remotely control the movement of the robot. Both the robot and remote station have cameras, monitors, speakers and microphones to allow for two-way video/audio communication. The robot camera provides video images to a screen at the remote station so that the user can view the robot's surroundings and move the robot accordingly.

The screen of the remote station is either a computer monitor or a flat screen of a laptop computer. Such screens have a limited range of view. It would be desirable to increase the viewing angle of the remote station screen so that multiple people can see what is being captured by the camera of the mobile robot.

### BRIEF SUMMARY OF THE INVENTION

A remote controlled robot system that includes a mobile robot and a remote control station. The remote control station transmits commands to control the mobile robot. The mobile robot has a camera that captures an image. The remote control station includes a monitor that displays the image captured by the robot camera. The system also includes a projector that is coupled to the remote control station and projects the image.

### BRIEF DESCRIPTION OF THE DRAWINGS

FIG. 1 is an illustration of a robotic system;

FIG. 2 is a schematic of an electrical system of a robot;

FIG. 3 is a further schematic of the electrical system of the robot;

FIG. 4 is a graphical user interface of a remote station;

FIG. 5 is similar to FIG. 4 showing a portion of a non-zoom image highlighted;

FIG. 6 is similar to FIG. 4 showing a zoom image being displayed by a robot view field;

FIG. 7 is similar to FIG. 4 showing a message that indicates a camera position has been stored.

### DETAILED DESCRIPTION

Disclosed is a remote controlled robot system that includes a mobile robot and a remote control station. The mobile robot includes a camera that captures an image. The remote control station may include a monitor that displays the image captured by the robot camera. A projector is coupled to the remote control station to project the image. The system allows for the projection of the image captured by the robot to a relatively large viewing audience. The audience can thus view images provided by a moving robot.

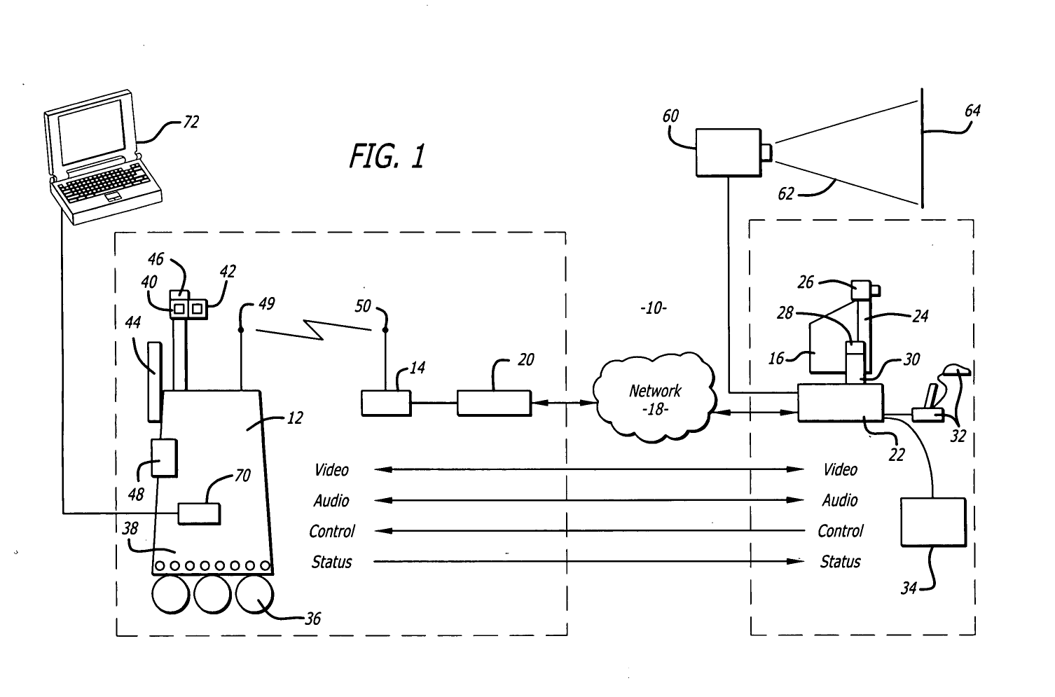

Referring to the drawings more particularly by reference numbers, FIG. 1 shows a robotic system 10 that can be used to conduct a remote visit. The robotic system 10 includes a robot 12, a base station 14 and a remote control station 16. The remote control station 16 may be coupled to the base station 14 through a network 18. By way of example, the network 18 may be either a packet switched network such as the Internet, or a circuit switched network such has a Public Switched Telephone Network (PSTN) or other broadband system. The base station 14 may be coupled to the network 18 by a modem 20 or other broadband network interface device. By way of example, the base station 14 may be a wireless router. Alternatively, the robot 12 may have a direct connection to the network thru for example a satellite.

The remote control station 16 may include a computer 22 that has a monitor 24, a camera 26, a microphone 28 and a speaker 30. The computer 22 may also contain an input device 32 such as a joystick and/or a mouse and a keyboard 34. The control station 16 is typically located in a place that is remote from the robot 12. Although only one remote control station 16 is shown, the system 10 may include a plurality of remote stations. In general any number of robots 12 may be controlled by any number of remote stations 16 or other robots 12. For example, one remote station 16 may be coupled to a plurality of robots 12, or one robot 12 may be coupled to a plurality of remote stations 16, or a plurality of robots 12.

Each robot 12 includes a movement platform 36 that is attached to a robot housing 38. Also attached to the robot housing 36 is a pair of cameras 40 and 42, a monitor 44, a microphone(s) 46 and a speaker(s) 48. The microphone 46 and speaker 30 may create a stereophonic sound. The robot 12 may also have an antenna 49 that is wirelessly coupled to an antenna 50 of the base station 14. The system 10 allows a user at the remote control station 16 to move the robot 12 through operation of the input device 32. The robot cameras 40 and 42 are coupled to the remote monitor 24 so that a user at the remote station 16 can view a patient. Likewise, the robot monitor 44 is coupled to the remote camera 26 so that the patient can view the user. The microphones 28 and 46, and speakers 30 and 48, allow for audible communication between the patient and the user.

Camera 40 may provide a wide angle view. Conversely, camera 42 may contain a zoom lens to provide a narrow angle view. Camera 42 can capture a zoom image that is transmitted to the remote control station. Camera 40 can capture a non-zoom image that can be transmitted to the remote control station. Although two cameras are shown and described, it is to be understood that the robot may contain only one camera that has the capability to provide a zoom image and a non-zoom image.

The remote station computer 22 may operate Microsoft OS software and WINDOWS XP or other operating systems such as LINUX. The remote computer 22 may also operate a video driver, a camera driver, an audio driver and a joystick driver. The video images may be transmitted and received with compression software such as MPEG CODEC.

A projector 60 is connected to the remote control station 16. By way of example, the projector 60 may be a product sold by Hewlett Packard under the name HP xp7010 Digital Projector. The projector 60 may be connected to a video output port of the computer 22.

The projector 60 projects an image 62 captured by a camera 40 and/or 42 of the robot. By way of example, the image 62 can be projected onto a screen 64. The operator can move the robot to provide a continually changing image 62 that is projected onto the screen 64. By way of example, a doctor can move the robot to various patient rooms of a health care facility. The audience may be students who are able to view patients with the doctor. Likewise, a business professional may move the robot throughout a business facility to allow the audience to also view the facility.

The system also allows someone to provide a “remote mobile presentation”. For example, a person located at the robot location can move around while instructing or otherwise presenting to a remote audience viewing the image projected by the projector 60.

The robot 12 may include one or more I/O inputs 70 such as USB, VGA, Y-video/audio electrical connectors. An electronic device 72 such as a laptop computer or an electronic camera can be connected to one or more of the ports 70. An image can be transmitted from the electronic device 72 to the remote station through the mobile robot 12. The image may be video and/or graphical in nature. The ports allow someone at the robot location to utilize the robot as a portable network outlet. The image provided by the electronic device 72 can be projected by the projector 60.

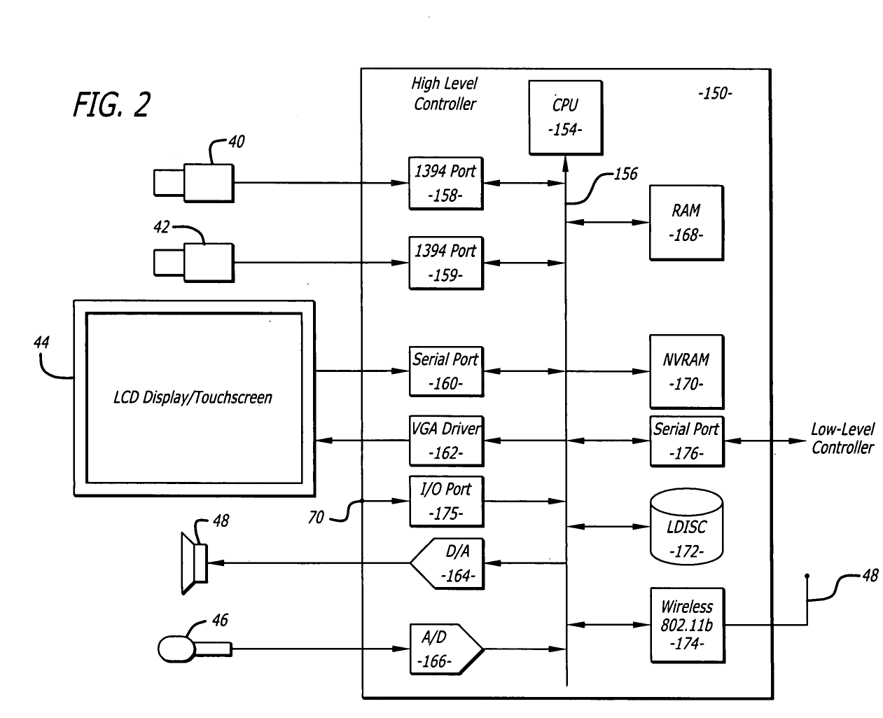

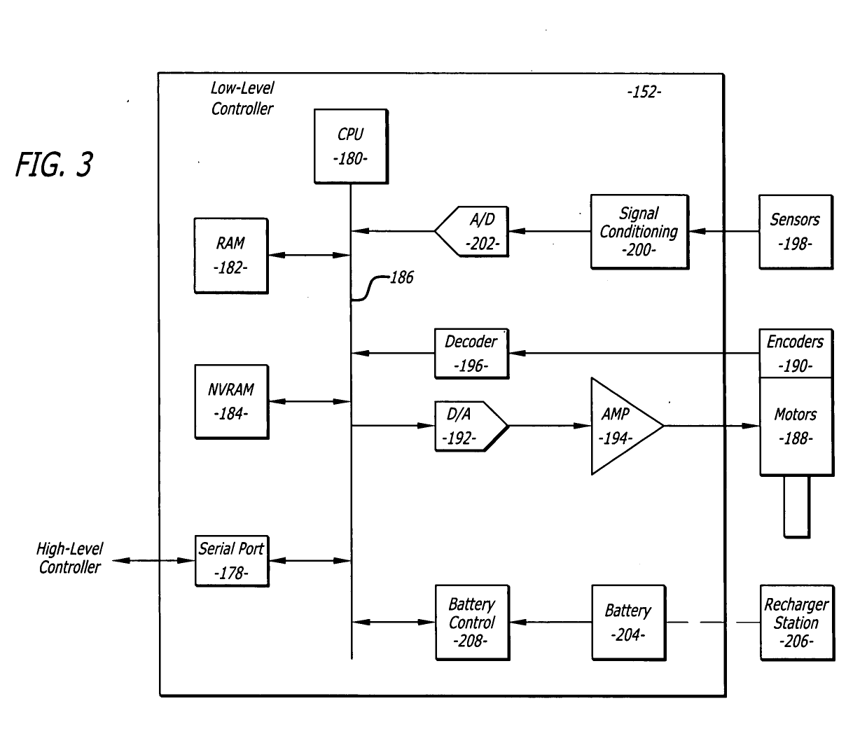

FIGS. 2 and 3 show an embodiment of a robot 12. Each robot 12 may include a high level control system 150 and a low level control system 152. The high level control system 150 may include a processor 154 that is connected to a bus 156. The bus 56 is coupled to the cameras 40 and 42 by an input/output (I/O) ports 158 and 160, respectively. The monitor 44 is coupled to the bus 156 by a serial output port 160 and a VGA driver 162. The monitor 44 may include a touchscreen function that allows the patient to enter input by touching the monitor screen.

The speaker 48 is coupled to the bus 156 by a digital to analog converter 164. The microphone 46 is coupled to the bus 156 by an analog to digital converter 166. The high level controller 150 may also contain random access memory (RAM) device 168, a non-volatile RAM device 170 and a mass storage device 172 that are all coupled to the bus 156. The mass storage device 172 may contain medical files of the patient that can be accessed by the user at the remote control station 16. For example, the mass storage device 172 may contain a picture of the patient. The user, particularly a health care provider, can recall the old picture and make a side by side comparison on the monitor 24 with a present video image of the patient provided by the camera 40. The robot antennae 48 may be coupled to a wireless transceiver 174. By way of example, the transceiver 174 may transmit and receive information in accordance with IEEE 802.11b.

The robot 12 may include an I/O port 175, such as a USB, auxiliary VGA or Y-video audio ports(s). The port 175 can be connected to an external device such as a computer or a digital camera. Information, such as video, graphics, text, etc., can be transmitted to the remote station through the I/O port 175 of the robot 12. By way of example, the screen of the computer 72 (see FIG. 1) can be projected by projector 60.

The controller 154 may operate with a LINUX OS operating system. The controller 154 may also operate MS WINDOWS along with video, camera and audio drivers for communication with the remote control station 16. Video information may be transceived using MPEG CODEC compression techniques. The software may allow the user to send e-mail to the patient and vice versa, or allow the patient to access the Internet. In general the high level controller 150 operates to control communication between the robot 12 and the remote control station 16.

The remote control station 16 may include a computer that is similar to the high level controller 150. The computer would have a processor, memory, I/O, software, firmware, etc. for generating, transmitting, receiving and processing information.

The high level controller 150 may be linked to the low level controller 152 by serial ports 176 and 178. The low level controller 152 includes a processor 180 that is coupled to a RAM device 182 and non-volatile RAM device 184 by a bus 186. Each robot 12 contains a plurality of motors 188 and motor encoders 190. The motors 188 can actuate the movement platform and move other parts of the robot such as the monitor and camera. The encoders 190 provide feedback information regarding the output of the motors 188. The motors 188 can be coupled to the bus 186 by a digital to analog converter 192 and a driver amplifier 194. The encoders 190 can be coupled to the bus 186 by a decoder 196. Each robot 12 also has a number of proximity sensors 198 (see also FIG. 1). The position sensors 198 can be coupled to the bus 186 by a signal conditioning circuit 200 and an analog to digital converter 202.

The low level controller 152 runs software routines that mechanically actuate the robot 12. For example, the low level controller 152 provides instructions to actuate the movement platform to move the robot 12. The low level controller 152 may receive movement instructions from the high level controller 150. The movement instructions may be received as movement commands from the remote control station or another robot. Although two controllers are shown, it is to be understood that each robot 12 may have one controller, or more than two controllers, controlling the high and low level functions.

The various electrical devices of each robot 12 may be powered by a battery(ies) 204. The battery 204 may be recharged by a battery recharger station 206 (see also FIG. 1). The low level controller 152 may include a battery control circuit 208 that senses the power level of the battery 204. The low level controller 152 can sense when the power falls below a threshold and then send a message to the high level controller 150.

The system 10 may be the same or similar to a robotic system provided by the assignee InTouch-Health, Inc. of Santa Barbara, Calif. under the name RP-6. The system may also be the same or similar to the system disclosed in U.S. Pat. No. 6,925,357 issued to Wang et al. on Aug. 2, 2005, which is hereby incorporated by reference.

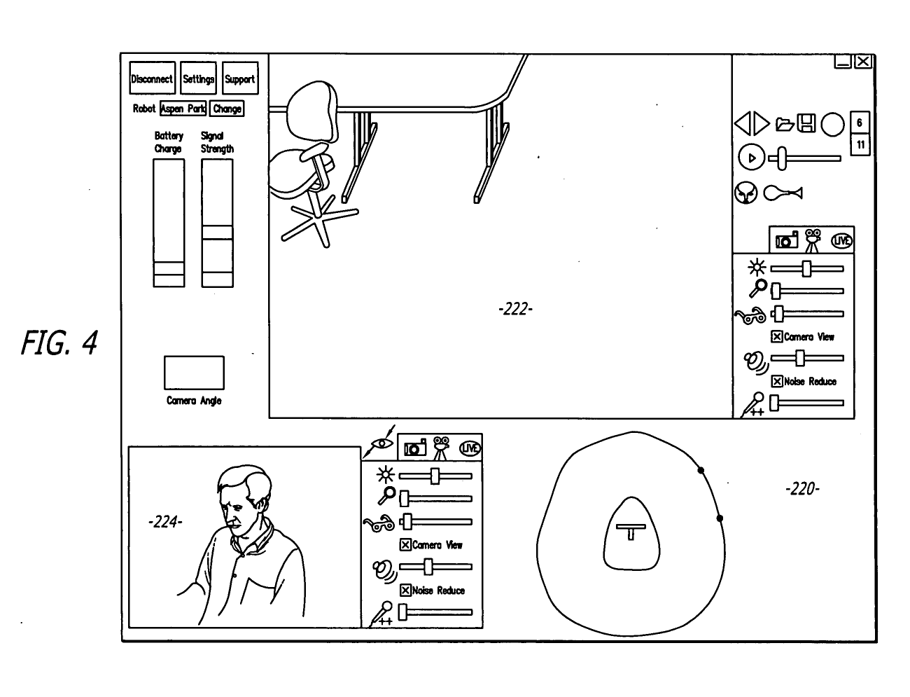

FIG. 4 shows a display user interface (“DUI”) 220 that can be displayed at the remote station 16. The DUI 220 may include a robot view field 222 that displays a video image provided by the camera of the robot. The projector 60 may also display the image shown in the robot view field 222. The DUI 220 may include a station view field 224 that displays a video image provided by the camera of the remote station 16. The DUI 220 may be part of an application program stored and operated by the computer 22 of the remote station 16.

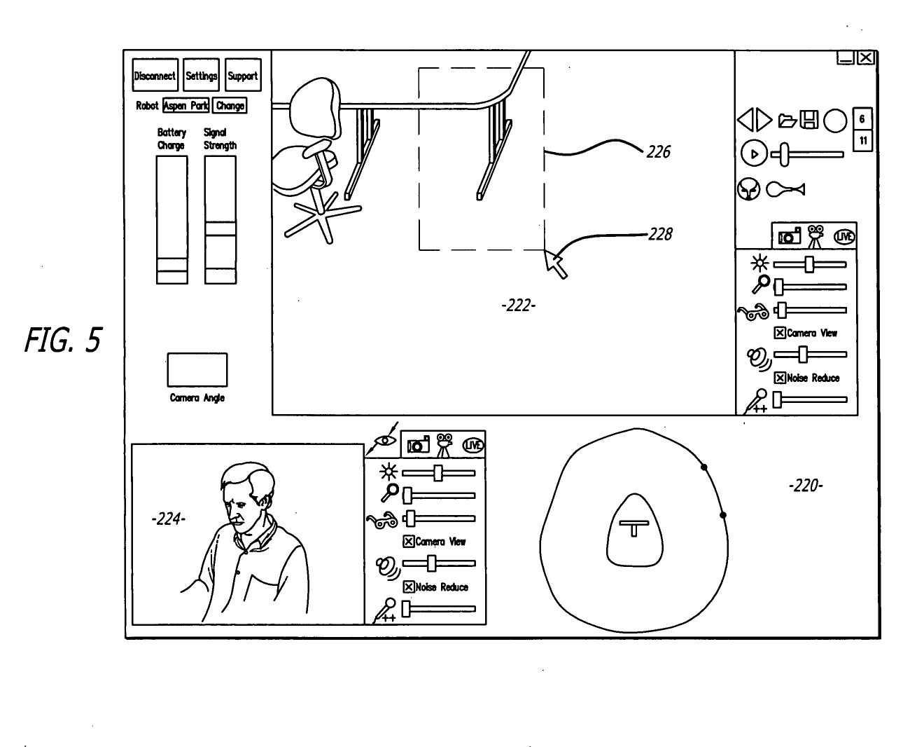

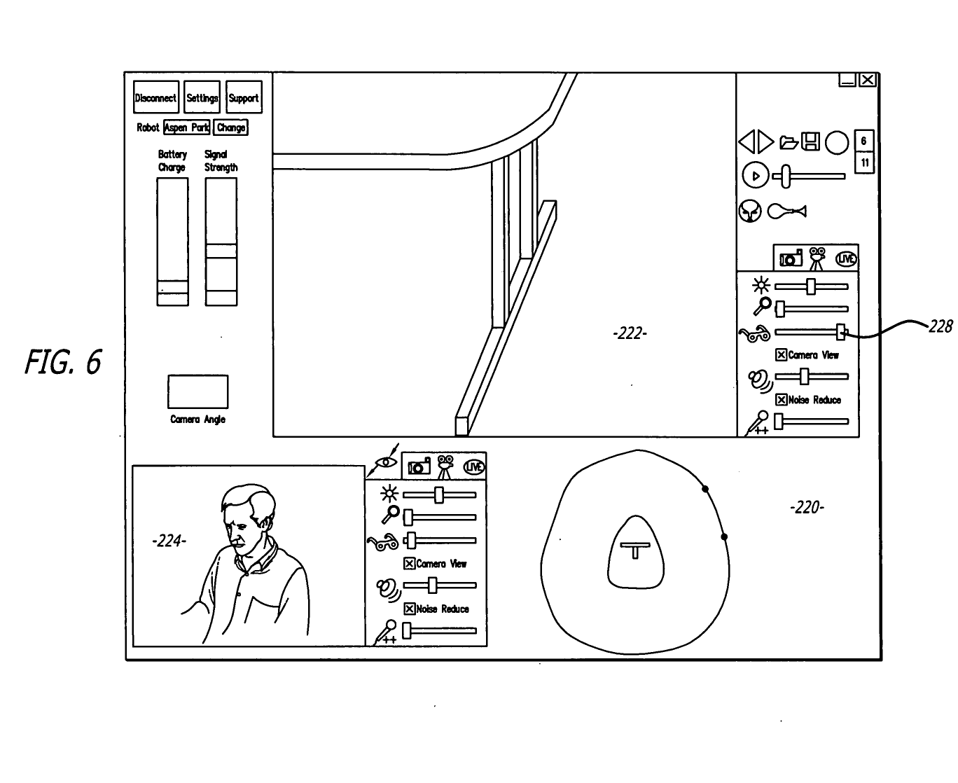

The robot view field 222 may display a non-zoom image provided by the camera system of the robot. As shown by FIGS. 5 and 6, the user can highlight a portion of the non-zoom image to display a zoom image that corresponds to the highlighted area 226. By way of example, the highlighted area 226 can be initiated by left-clicking a mouse. The user can then drag the cursor 228, while holding down the left-click, to create the highlighted area 226. When the user releases the left-click, the remote station transmits commands to move the robot camera to point at the center of the highlighted area 226 and provide the zoom image corresponding to the area. Alternatively, the user can click on the mouse and a zoom area centered about the cursor will be displayed. The user can switch back to the non-zoom image by manipulating graphical icon 228 to move the slide bar to a far left position. This feature allows a user to readily switch between zoom and non-zoom images provided by the robot camera system. Thus a user can utilize the non-zoom image while moving the robot, and the zoom image feature to take a closer look at people or objects in the field of view.

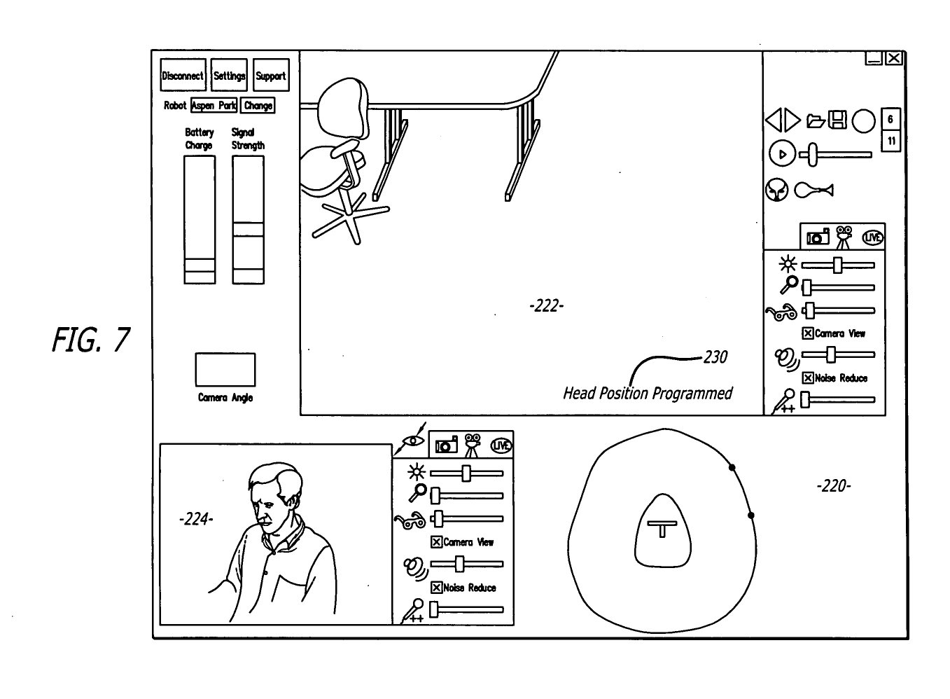

The remote control station can store camera positions so that the user can readily go to a desired camera position. By way of example, a camera location can be stored by depressing a key on the keyboard. The F4 key may be depressed to store a camera position. As shown in FIG. 7 a visual indication 230 may be displayed to indicate to the user that the camera position has been stored. Subsequently pressing the key will cause the remote station to transmit a command(s) to move the robot camera system to the desired position. Other keys such as F5 through F12 can be used to create 9 potential stored camera locations. A new camera position can be stored by pressing and holding down one of the keys F4-F12.

The mouse 32 can be used to move the cameras of the robot. Movement of the mouse 32 may cause a corresponding movement of the cameras. The scale between the mouse and the camera movements may be varied by the user. Movement of the mouse may also cause the system to display zoom and non-zoom images.

In operation, the robot 12 may be placed in a home or a facility where one or more patients are to be monitored and/or assisted. The facility may be a hospital or a residential care facility. By way of example, the robot 12 may be placed in a home where a health care provider may monitor and/or assist the patient. Likewise, a friend or family member may communicate with the patient. The cameras and monitors at both the robot and remote control stations allow for teleconferencing between the patient and the person at the remote station(s).

The robot 12 can be maneuvered through the home or a facility by manipulating the input device 32 at a remote station 16. The robot 10 may be controlled by a number of different users. To accommodate for this the robot may have an arbitration system. The arbitration system may be integrated into the operating system of the robot 12. For example, the arbitration technique may be embedded into the operating system of the high-level controller 150.

By way of example, the users may be divided into classes that include the robot itself, a local user, a caregiver, a doctor, a family member, or a service provider. The robot 12 may override input commands that conflict with robot operation. For example, if the robot runs into a wall, the system may ignore all additional commands to continue in the direction of the wall. A local user is a person who is physically present with the robot. The robot could have an input device that allows local operation. For example, the robot may incorporate a voice recognition system that receives and interprets audible commands.

A caregiver is someone who remotely monitors the patient. A doctor is a medical professional who can remotely control the robot and also access medical files contained in the robot memory. The family and service users remotely access the robot. The service user may service the system such as by upgrading software, or setting operational parameters.

The robot 12 may operate in one of two different modes; an exclusive mode, or a sharing mode. In the exclusive mode only one user has access control of the robot. The exclusive mode may have a priority assigned to each type of user. By way of example, the priority may be in order of local, doctor, caregiver, family and then service user. In the sharing mode two or more users may share access with the robot. For example, a caregiver may have access to the robot, the caregiver may then enter the sharing mode to allow a doctor to also access the robot. Both the caregiver and the doctor can conduct a simultaneous tele-conference with the patient.

The arbitration scheme may have one of four mechanisms; notification, timeouts, queue and call back. The notification mechanism may inform either a present user or a requesting user that another user has, or wants, access to the robot. The timeout mechanism gives certain types of users a prescribed amount of time to finish access to the robot. The queue mechanism is an orderly waiting list for access to the robot. The call back mechanism informs a user that the robot can be accessed. By way of example, a family user may receive an e-mail message that the robot is free for usage. Tables I and II, show how the mechanisms resolve access request from the various users.

TABLE I

| | Access | Medical | Command | Software/Debug | Set |
|---|---|---|---|---|---|
| User | Control | Record | Override | Access | Priority |
| Robot | No | No | Yes (1) | No | No |
| Local | No | No | Yes (2) | No | No |
| Caregiver | Yes | Yes | Yes (3) | No | No |
| Doctor | No | Yes | No | No | No |
| Family | No | No | No | No | No |
| Service | Yes | No | Yes | Yes | Yes |

TABLE II

| | Requesting User | | | | | |
|---|---|---|---|---|---|---|
| | Local | | Caregiver | Doctor | Family | Service |
| Current | Local | Not Allowed | Warn current user of | Warn current user of | Warn current user of | Warn current user of |
| User | | | pending user | pending user | pending user | pending user |
| | | | Notify requesting | Notify requesting user | Notify requesting user | Notify requesting |
| | | | user that system is in | that system is in use | that system is in use | user that system is in |
| | | | use | Set timeout = 5 m | Set timeout = 5 m | use |
| | | | Set timeout | | Call back | No timeout |
| | | | | | | Call back |
| | Caregiver | Warn current user | Not Allowed | Warn current user of | Warn current user of | Warn current user of |
| | | of pending user. | | pending user | pending user | pending user |
| | | Notify requesting | | Notify requesting user | Notify requesting user | Notify requesting |
| | | user that system is | | that system is in use | that system is in use | user that system is in |
| | | in use. | | Set timeout = 5 m | Set timeout = 5 m | use |
| | | Release control | | Queue or callback | | No timeout |
| | | | | | | Callback |
| | Doctor | Warn current user | Warn current user of | Warn current user of | Notify requesting user | Warn current user of |
| | | of pending user | pending user | pending user | that system is in use | pending user |
| | | Notify requesting | Notify requesting | Notify requesting user | No timeout | Notify requesting |
| | | user that system is | user that system is in | that system is in use | Queue or callback | user that system is in |
| | | in use | use | No timeout | | use |
| | | Release control | Set timeout = 5 m | Callback | | No timeout |
| | | | | | | Callback |
| | Family | Warn current user | Notify requesting | Warn current user of | Warn current user of | Warn current user of |
| | | of pending user | user that system is in | pending user | pending user | pending user |
| | | Notify requesting | use | Notify requesting user | Notify requesting user | Notify requesting |
| | | user that system is | No timeout | that system is in use | that system is in use | user that system is in |
| | | in use | Put in queue or | Set timeout = 1 m | Set timeout = 5 m | use |
| | | Release Control | callback | | Queue or callback | No timeout |
| | | | | | | Callback |
| | Service | Warn current user | Notify requesting | Warn current user of | Warn current user of | Not Allowed |
| | | of pending user | user that system is in | request | pending user | |
| | | Notify requesting | use | Notify requesting user | Notify requesting user | |
| | | user that system is | No timeout | that system is in use | that system is in use | |
| | | in use | Callback | No timeout | No timeout | |
| | | No timeout | | Callback | Queue or callback | |

The information transmitted between the station 16 and the robot 12 may be encrypted. Additionally, the user may have to enter a password to enter the system 10. A selected robot is then given an electronic key by the station 16. The robot 12 validates the key and returns another key to the station 16. The keys are used to encrypt information transmitted in the session.

The robot 12 and remote station 16 transmit commands through the broadband network 18. The commands can be generated by the user in a variety of ways. For example, commands to move the robot may be generated by moving the joystick 32 (see FIG. 1). The commands are preferably assembled into packets in accordance with TCP/IP protocol. Table III provides a list of control commands that are generated at the remote station and transmitted to the robot through the network.

TABLE III
Control Commands

| Command | Example | Description |
|---|---|---|
| drive | drive 10.0 0.0 5.0 | The drive command directs the robot to move |
| | | at the specified velocity (in cm/sec) in the |
| | | (x, y) plane, and turn its facing at the |
| | | specified rate (degrees/sec). |
| goodbye | goodbye | The goodbye command terminates a user |
| | | session and relinquishes control of the |
| | | robot |
| gotoHomePosition | gotoHomePosition 1 | The gotoHomePosition command moves the head |
| | | to a fixed “home” position (pan and tilt), |
| | | and restores zoom to default value. The |
| | | index value can be 0, 1, or 2. The exact |
| | | pan/tilt values for each index are specified |
| | | in robot configuration files. |
| head | head vel pan 5.0 tilt | The head command controls the head motion. |
| | 10.0 | It can send commands in two modes, |
| | | identified by keyword: either positional |
| | | (“pos”) or velocity (“vol”). In velocity |
| | | mode, the pan and tilt values are desired |
| | | velocities of the head on the pan and tilt |
| | | axes, in degree/sec. A single command can |
| | | include just the pan section, or just the |
| | | tilt section, or both. |
| keepalive | keepalive | The keepalive command causes no action, but |
| | | keeps the communication (socket) link open |
| | | so that a session can continue. In scripts, |
| | | it can be used to introduce delay time into |
| | | the action. |
| odometry | odometry 5 | The odometry command enables the flow of |
| | | odometry messages from the robot. The |
| | | argument is the number of times odometry is |
| | | to be reported each second. A value of 0 |
| | | turns odometry off. |
| reboot | reboot | The reboot command causes the robot computer |
| | | to reboot immediately. The ongoing session |
| | | is immediately broken off. |
| restoreHeadPosition | restoreHeadPosition | The restoreHeadPosition functions like the |
| | | gotoHomePosition command, but it homes the |
| | | head to a position previously saved with |
| | | gotoHomePosition. |
| saveHeadPosition | saveHeadPosition | The saveHeadPosition command causes the |
| | | robot to save the current head position (pan |
| | | and tilt) in a scratch location in temporary |
| | | storage so that this position can be |
| | | restored. Subsequent calls to |
| | | “restoreHeadPosition” will restore this |
| | | saved position. Each call to |
| | | saveHeadPosition overwrites any previously |
| | | saved position. |
| setCameraFocus | setCameraFocus 100.0 | The setCameraFocus command controls focus |
| | | for the camera on the robot side. The value |
| | | sent is passed “raw” to the video |
| | | application running on the robot, which |
| | | interprets it according to its own |
| | | specification. |
| setCameraZoom | setCameraZoom 100.0 | The setCameraZoom command controls zoom for |
| | | the camera on the robot side. The value |
| | | sent is passed “raw” to the video |
| | | application running on the robot, which |
| | | interprets it according to its own |
| | | specification. |
| shutdown | Shutdown | The shutdown command shuts down the robot |
| | | and powers down its computer. |
| stop | stop | The stop command directs the robot to stop |
| | | moving immediately. It is assumed this will |
| | | be as sudden a stop as the mechanism can |
| | | safely accommodate. |
| timing | Timing 3245629 500 | The timing message is used to estimate |
| | | message latency. It holds the UCT value |
| | | (seconds + milliseconds) of the time the |
| | | message was sent, as recorded on the sending |
| | | machine. To do a valid test, you must |
| | | compare results in each direction (i.e., |
| | | sending from machine A to machine B, then |
| | | from machine B to machine A) in order to |
| | | account for differences in the clocks |
| | | between the two machines. The robot records |
| | | data internally to estimate average and |
| | | maximum latency over the course of a |
| | | session, which it prints to log files. |
| userTask | userTask “Jane Doe” | The userTask command notifies the robot of |
| | “Remote Visit” | the current user and task. It typically is |
| | | sent once at the start of the session, |
| | | although it can be sent during a session if |
| | | the user and/or task change. The robot uses |
| | | this information for record-keeping. |

Table IV provides a list of reporting commands that are generated by the robot and transmitted to the remote station through the network.

TABLE IV
Reporting Commands

| Command | Example | Description |
|---|---|---|
| abnormalExit | abnormalExit | This message informs the user that the robot |
| | | software has crashed or otherwise exited |
| | | abnormally. Te robot software catches top- |
| | | level exceptions and generates this message |
| | | if any such exceptions occur. |
| bodyType | bodyType 3 | The bodyType message informs the station |
| | | which type body (using the numbering of the |
| | | mechanical team) the current robot has. |
| | | This allows the robot to be drawn correctly |
| | | in the station user interface, and allows |
| | | for any other necessary body-specific |
| | | adjustments. |
| driveEnabled | driveEnabled true | This message is sent at the start of a |
| | | session to indicate whether the drive system |
| | | is operational. |
| emergencyShutdown | emergencyShutdown | This message informs the station that the |
| | | robot software has detected a possible |
| | | “runaway” condition (an failure causing the |
| | | robot to move out of control) and is |
| | | shutting the entire system down to prevent |
| | | hazardous motion. |
| odometry | odometry 10 20 340 | The odometry command reports the current |
| | | (x, y) position (cm) and body orientation |
| | | (degrees) of the robot, in the original |
| | | coordinate space of the robot at the start |
| | | of the session. |
| sensorGroup | group_data | Sensors on the robot are arranged into |
| | | groups, each group of a single type (bumps, |
| | | range sensors, charge meter, etc.) The |
| | | sensorGroup message is sent once per group |
| | | at the start of each session. It contains |
| | | the number, type, locations, and any other |
| | | relevant data for the sensors in that group. |
| | | The station assumes nothing about the |
| | | equipment carried on the robot; everything |
| | | it knows about the sensors comes from the |
| | | sensorGroup messages. |
| sensorState | groupName state data | The sensorState command reports the current |
| | | state values for a specified group of |
| | | sensor. The syntax and interpretation for |
| | | the state data is specific to each group. |
| | | This message is sent once for each group at |
| | | each sensor evaluation (normally several |
| | | times per second). |
| systemError | systemError | This message informs the station user of a |
| | driveController | failure in one of the robot's subsystems. |
| | | The error_type argument indicates which |
| | | subsystem failed, including driveController, |
| | | sensorController, headHome. |
| systemInfo | systemInfo wireless 45 | This message allows regular reporting of |
| | | information that falls outside the sensor |
| | | system such as wireless signal strength. |
| text | text “This is some | The text string sends a text string from the |
| | text” | robot to the station, where the string is |
| | | displayed to the user. This message is used |
| | | mainly for debugging. |
| version | version 1.6 | This message identifies the software version |
| | | currently running on the robot. It is sent |
| | | once at the start of the session to allow |
| | | the station to do any necessary backward |
| | | compatibility adjustments. |

The processor 154 of the robot high level controller 150 may operate a program that determines whether the robot 12 has received a robot control command within a time interval. For example, if the robot 12 does not receive a control command within 2 seconds then the processor 154 provides instructions to the low level controller 150 to stop the robot 12. Although a software embodiment is described, it is to be understood that the control command monitoring feature could be implemented with hardware, or a combination of hardware and software. The hardware may include a timer that is reset each time a control command is received and generates, or terminates, a command or signal, to stop the robot.

The remote station computer 22 may monitor the receipt of video images provided by the robot camera. The computer 22 may generate and transmit a STOP command to the robot if the remote station does not receive or transmit an updated video image within a time interval. The STOP command causes the robot to stop. By way of example, the computer 22 may generate a STOP command if the remote control station does not receive a new video image within 2 seconds. Although a software embodiment is described, it is to be understood that the video image monitoring feature could be implemented with hardware, or a combination of hardware and software. The hardware may include a timer that is reset each time a new video image is received and generates, or terminates, a command or signal, to generate the robot STOP command.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A remote controlled robot system, comprising:
a mobile robot with a screen and a robot camera that captures a robot image;
a remote control station that transmits commands to control said mobile robot, said remote control station includes a monitor that displays the robot image captured by said robot camera, said remote control station including a camera that can capture a station image that is displayed by said mobile robot screen; and,
a projector that is coupled to said remote control station and projects the image captured by said robot camera.

2. The system of claim 1, wherein said projector is connected to an I/O port of said remote control station.

3. The system of claim 1, wherein said robot camera provides a zoom image and a non-zoom image.

4. The system of claim 1, wherein said robot includes an I/O port that is connected to an electronic device.

5. The system of claim 1, wherein said electronic device provides a feed image that is projected by said projector.

6. The system of claim 5, wherein said feed image is graphical.

7. The system of claim 5, wherein said feed image is video.

8. The system of claim 1, wherein said mobile robot is wirelessly coupled to a wireless transmitter.

9. The system of claim 8, further comprising a broadband network coupled to said wireless transmitter and said remote control station.

10. A method for projecting a remotely captured image, comprising:
capturing a robot image with a robot camera of a mobile robot;
transmitting the robot image captured by the robot camera to a remote control station used to control movement of the mobile robot;
displaying the image captured by the robot camera on a monitor of the remote control station;
projecting the image captured by the robot camera;
capturing a station image with a camera of the remote station;
transmitting the station image to the mobile robot; and,
displaying the station image on a screen of the mobile robot.

11. The method of claim 10, wherein the robot camera captures either a zoom image or a non-zoom image.

12. The method of claim 10, further comprising transmitting a feed image from an electronic device connected to the mobile robot to the remote control station and projecting the feed image.

13. The method of claim 12, wherein the feed image is graphical.

14. The method of claim 12, wherein the feed image is video.

15. The method of claim 10, wherein the image is transmitted through a wireless transmitter and a broadband network.

16. The method of claim 10, further comprising transmitting movement commands from the remote control station to the mobile robot and moving the mobile robot in response to the movement commands.
